(19) United States
(12) Patent Application Publication
(10) Pub. No.: US 2010/0201124 A1
(43) Pub. Date: Aug. 12, 2010

(54) FITTING WITH BUSHING FOR CORRUGATED STAINLESS STEEL TUBING

(76) Inventors: Scott Duquette, East Windsor, CT (US); Franz Kellar, Gastonia, NC (US); Harold Crowder, Concord, NC (US); Vanwijak Eowsakul, Holyoke, MA (US)

Correspondence Address: EDWARDS ANGELL PALMER & DODGE LLP, P.O. BOX 55874, BOSTON, MA, 02205, US

(21) Appl. No.: 12/598,402

(22) PCT Filed: May 30, 2008
(86) PCT No.: PCT/US08/06887

§ 371 Date: Mar. 8, 2010

Related U.S. Application Data
(60) Provisional application No. 60/932,199, filed on May 30, 2007.

(51) Int. Cl. F16L 19/065

(52) U.S. Cl. 285/382.7

(57) ABSTRACT

A fitting incorporating a bushing for forming a seal between a length of corrugated tubing and the fitting, and methods of actuating the fitting and forming a seal using the fitting and tubing are provided. The tubing can be corrugated stainless steel tubing having a jacket that at least partially covers the tubing. The fitting includes a bushing having a substantially open configuration, the bushing configured to engage at least one corrugation groove. When a nut is advanced, the bushing applies pressure to the tubing to crush at least one initial corrugation to form a metal-to-metal seal that is gas and liquid tight.

### FIELD OF INVENTION

The present invention relates to gas and liquid piping systems, and more particularly to a fitting incorporating a metal-to-metal seal in which a bushing is provided between a length of corrugated tubing and the fitting to facilitate forming the metal-to-metal seal.

### BACKGROUND OF THE INVENTION

Gas and liquid piping systems which utilize corrugated stainless steel tubing (“CSST”) and fittings are known. Such piping systems can be designed for use in combination with elevated gas pressures of up to about 0.03 megapascals (MPa) or more, and provide advantages over traditional rigid black iron piping systems in terms of ease and speed of installation, elimination of onsite measuring, and reduction in the need for certain fittings such as elbows, tees, and couplings. Undesirably, some fittings conventionally used with CSST systems include fiber sealing gaskets or polymer O-rings which can deteriorate over time, or pre-flared tubing ends, which suffer from reliability problems.

A suitable self-aligning and self-flaring fitting assembly, which does not require the use of a sealing gasket, is disclosed in U.S. Pat. No. 6,173,995 to Mau (“the '995 patent”), which is incorporated by reference herein. The '995 patent is owned by Titeflex Corporation, assignee of the present application, and discloses a self-flaring fitting assembly for use with semi-flexible, convoluted tubes or pipes, including CSST systems. The fitting assembly includes an externally-threaded adapter having a pipe receiving bore divided into a plurality of sections of different diameters, a nut threaded to a first end of the adapter, and a split bushing assembly with at least two internally spaced ribs for engaging circumferential grooves of the corrugated tubing, as shown in FIGS. 2-5 of the '995 patent. The fitting assembly disclosed in the '995 patent forms a seal by compressing an end corrugation or convolution between an internal stop shoulder of the adapter and one end of the split bushing assembly. A seal formed according to the above mechanism may be suitable for preventing leaking of gas and/or liquid through the pipe and fitting connection. However, in some instances, excessive torque may be required to create a seal on certain types of tubing. It would also be desirable to generate a uniform force, per circumferential unit distance, sealing interface that can provide a known sealing pressure per unit area of corrugated sealing surface engaged.

Moreover, the fitting assembly described by the '995 patent requires the installer to slide the nut over the tubing and place the bushing on the tubing. These installation requirements result in several drawbacks. First, the installer likely will need to disassemble the fitting for installation, increasing the time required for installation. Second, disassembly of the fitting increases the complexity and risk involved in installation. For example, a foreign object, such as swarf or turnings from other pipe fitting activities may be introduced to the fitting, potentially interfering with the seal. Third, the installer is required to handle the freshly cut tubing which may contain sharp edges posing a risk of lacerations. Finally, the disassembly and reassembly of the fitting poses a risk of loss and/or damage to the bushing as well as the risk of cross-threading when the nut is reinstalled. For at least these reasons, it would be highly desirable to create a fitting that does not require disassembly prior to installation.

It would be desirable to provide a fitting having a suitable sealing mechanism for connecting the fitting to a length of tubing. Such a fitting preferably could be adapted for use with different types of tubing and fitting interfaces and other piping and tubing systems, particularly those designed for transporting gas and/or liquid.

In some fittings designed for use with CSST systems, an end corrugation of the tubing is compressed to form a metal-to-metal seal. Examples of such sealing arrangements include U.S. Pat. No. 6,428,052 to Albino et al., U.S. Pat. No. 6,877,781 to Edler, and U.S. Pat. No. 6,908,114 to Moner (“the '114 patent”). However, especially when larger sized fittings are used, a problem arises that the fittings require high amounts of torque to form an adequate seal with a length of tubing. Moreover, the '114 patent shows the use of a collet including a plurality of individual pieces. The use of multi-piece collets increases manufacturing costs and increases the risk of failure. Additionally, the '114 patent shows the use of a normally-closed collet. This normally-closed collet is forced open by the insertion of corrugated tubing through the collet. Such a design may require large forces to be applied to the tubing, in particular, to force a leading end corrugation through the collet. Such force could damage the tubing, the collet and/or the fitting. Moreover, a normally-closed collet may prevent a user from easily removing the tubing from the fitting if the user discovers that the tubing was inserted into the wrong fitting.

It would be desirable to provide an improved fitting configured for connection to a length of corrugated tubing, where the fitting produces a metal-to-metal seal through the use of a simple bushing or collet arrangement. The fitting and related devices and methods should overcome the deficiencies of the presently available fittings and sealing arrangements, for which it can be difficult to produce a suitable amount of torque, and which may require disassembly as part of installation or utilize complex bushing or collet designs, and in which a suitable circumferential sealing force per unit area has not heretofore been achieved.

### SUMMARY OF THE INVENTION

A fitting incorporating a bushing for forming a metal-to-metal seal between a length of corrugated tubing and the fitting, and methods of actuating the fitting and forming a seal using the fitting and tubing are disclosed. The tubing can be corrugated stainless steel tubing (CSST) commonly used in gas and liquid piping systems. The tubing can be at least partially covered with a jacket. According to the present invention, a suitable seal is formed without requiring excessive torque to form the seal.

The present invention relates to a sealing device for connecting a length of corrugated tubing to a fitting including at least a body member or adapter, a bushing, and an axial loading nut. The body member can include a sleeve portion. The bushing preferably is received in the sleeve portion of the body member, and has first and second ends and a plurality of fingers arranged in a substantially open configuration. The tubing is received through the bushing substantially without contacting the fingers of the bushing. The bushing fingers are configured to engage at least one corrugation groove of the tubing as the bushing is advanced. The axial loading nut is operably connected to the body member for advancing the first end of the bushing into engagement with the body member to form a seal. In particular, a metal-to-metal seal is formed when the bushing is forced against the body member, thereby collapsing at least one corrugation of the tubing.

The fingers may be formed such that the fingers interact with the sleeve portion of the body member to facilitate forming and sealing of the tubing. The geometry of the fingers can be selected from the group including: conical, angular, and other geometries corresponding to the sleeve portion. The radial advancing fingers of the bushing may additionally or alternatively have a geometry to engage one or more of the corrugation grooves of the tubing. The geometry can be selected from the group including: triangular, circular, elliptical, and other geometries corresponding to the tubing. Further, the bushing may be formed with at least one of a tab, a formed feature, a ring, a fold, and a flange.

The bushing preferably is positioned radially inside the sleeve portion of the body member. The bushing preferably is formed as a single piece, for example, by metal injection molding, but in certain embodiments, can be formed of more than one piece. The bushing may be circumferentially formed as a continuous piece, or may be a split bushing. The bushing can be made of metals, metal alloys, plastics, polymers, and/or elastomers.

The sleeve portion preferably is shaped to facilitate advancement of the bushing and engagement of the fingers. The axial loading nut may be positioned radially outside the sleeve portion. The length of corrugated tubing optionally can be partially or completely covered by a jacket, such that the fingers engage the jacket. The jacket-engaging fingers may reduce stress on a portion of the tubing between the region in which the fingers engage with the jacket and the one or more collapsed corrugations.

The fitting may further include an adapter configured to receive the sleeve portion. Additionally or alternatively, the metal-to-metal seal described herein may be an annular contact ring. In certain embodiments, the nut may be designed to limit the amount of torque or axial force that can be applied to the bushing. In some embodiments a washer is positioned between the nut and bushing.

The present invention also incorporates a method for connecting a length of corrugated tubing to a fitting. The method includes at least the step of providing a body member including a sleeve portion. A bushing is provided having first and second ends and a plurality of fingers in a substantially open configuration. The tubing is received through the bushing substantially without contacting the fingers of the bushing. The fingers are configured to engage at least one corrugation groove of the tubing as the bushing is advanced. The method further includes inserting the tubing into the sleeve portion and the bushing, and advancing an axial nut such that the fingers engage at least one corrugation groove of the tubing. The method further includes advancing the nut to advance the bushing to collapse the at least one corrugation groove against the body member to form a seal. In some embodiments, the bushing elastically deforms at a defined load rating. Additionally or alternatively, the tubing is covered by a jacket and advancing the axial nut further causes the bushing to engage the jacket.

Other aspects and embodiments of the invention are discussed below.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views and wherein:

FIG. 1 is a cross-sectional view of a length of corrugated tubing received in a fitting, which incorporates a bushing according to a preferred embodiment of the present invention;

FIG. 2 is a cross-sectional view of a length of corrugated tubing received in a fitting, which incorporates a bushing having a plurality of jacket-locking fingers according to another preferred embodiment of the present invention;

FIGS. 3(a) to 3(e) are cross-sectional views depicting the operation of the fitting shown in FIG. 2;

FIG. 4 is a cross-sectional view of a metal-to-metal seal formed using a fitting according to the present invention;

FIG. 5 is a perspective view of a bushing configured for use in the fitting of FIG. 2, where the bushing includes the plurality of jacket-locking fingers; and

FIG. 6 is a cross-sectional view of a fitting with a bushing having triangular fingers and a flanged distal end.

### DEFINITIONS

The instant invention is most clearly understood with reference to the following definitions:

As used in the specification and claims, the singular form “a”, “an” and “the” include plural references unless the context clearly dictates otherwise.

As used herein, the terms “corrugated stainless steel tubing” and “CSST” refer to any type of semi-flexible tubing or piping, which may accommodate corrosive or aggressive gases or liquids, and includes but is not limited to semi-flexible tubing or piping made from: thermoplastics, metal or metal alloy materials such as olefin-based plastics (e.g., polyethylene (PE)), fluorocarbon polymers (e.g., polytetrafluoroethylene (PTFE)), carbon steel, copper, brass, aluminum, titanium, nickel, and alloys thereof.

### DETAILED DESCRIPTION OF THE INVENTION

A fitting incorporating a bushing for forming a metal-to-metal seal between a length of corrugated tubing and the fitting, and methods of actuating the fitting and forming a seal using the fitting and tubing are disclosed. The tubing can be corrugated stainless steel tubing (CSST) commonly used in gas and liquid piping systems. The tubing can be at least partially covered with a jacket. According to the present invention, a suitable metal-to-metal seal is formed without requiring excessive torque to form the seal.

A fitting according to the present invention includes at least a body member or adapter incorporating a sleeve portion, an axial loading nut, and a bushing.

In some embodiments, the sleeve portion may be a separate component from the adapter, where the sleeve portion can be attached to the adapter during manufacturing, for example, by using any of a number of common techniques, in order to form a gas and fluid tight seal between the sleeve portion and the adapter. For example, the sleeve portion can be affixed to the adapter by crimping, or the sleeve portion can be press fit to the outer diameter of the adapter. Further suitable techniques for connecting the sleeve portion and the adapter include brazing and welding. Additionally or alternatively, a compound such as a resin, adhesive, or epoxy can be applied to an interface between the sleeve portion and the adapter to form a suitable bond. Optionally, the interface between the sleeve portion and adapter can include an O-ring, gasket, or other elastomeric material. However, in the embodiments depicted in the figures, the sleeve portion is part of the adapter, such that sleeve portion and adapter form a single piece. As used herein, the term “proximal” refers to a location closest to the adapter, whereas the term “distal” refers to a location closest to the tubing.

A length of tubing can be received in the distal end of the fitting. Preferably, the fitting is assembled with a bushing inside the sleeve portion and an axial nut loosely threaded on the outside of the sleeve portion. However, the nut and/or the bushing may be placed over the tubing before the tubing is inserted into the sleeve portion.

Prior to insertion of the tubing into the fitting, the bushing is in an uncompressed state. After the tubing is inserted, the nut is tightened onto the sleeve portion (i.e., the nut is rotated, causing it to move proximally). This proximal movement exerts force on the bushing, causing the bushing to engage one or more corrugation grooves of the tubing. The continued proximal movement advances the tubing, causing one or more corrugations received between an end of the bushing and a corresponding end of the adapter to collapse and form a metal-to-metal seal.

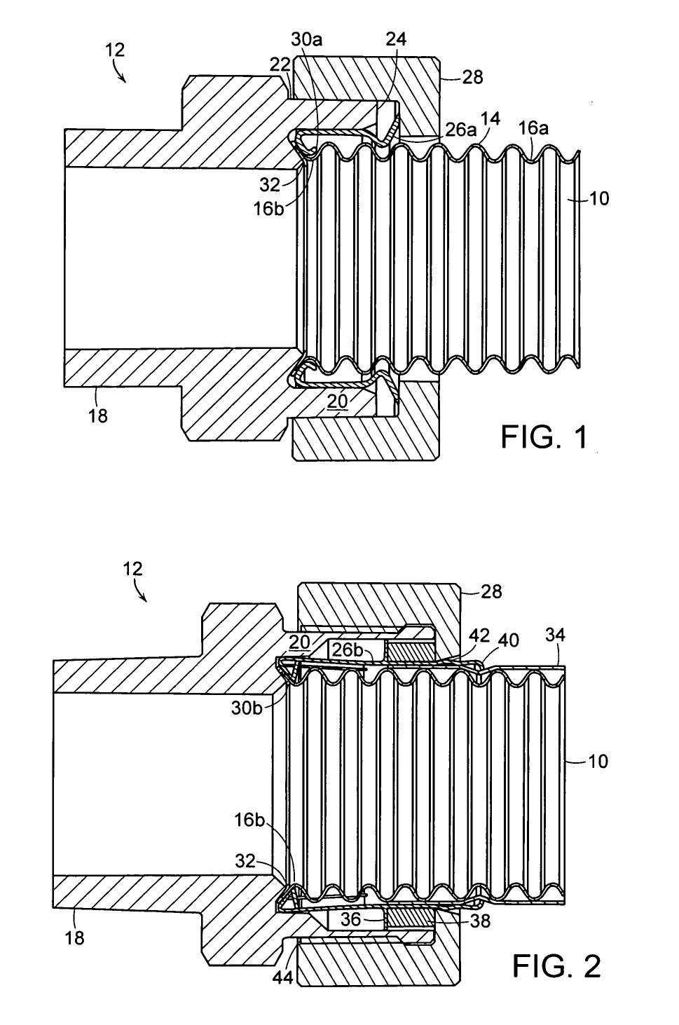

Referring to FIG. 1, a length of corrugated tubing 10 can be received in a fitting 12. The tubing 10 can be corrugated stainless steel tubing (CSST) commonly used for transporting gas and liquid. The tubing contains a number of corrugations 14 and corrugation grooves 16a, 16b. Preferably, the tubing 10 is at least partially covered by a jacket made of any suitable material, for example, polyethylene. In certain embodiments, the jacket can be peeled back from an end of the tubing 10, thereby exposing one or more corrugations of the tubing 10. For example, as shown in FIG. 2, a jacket 34 covering the tubing 10 has been peeled back to expose one or more corrugations. In FIG. 1, the tubing 10 is provided without a jacket.

The fitting 12 preferably includes at least an adapter (or body member) 18, where the adapter 18 preferably includes a sleeve portion 20. FIG. 1 depicts the fitting 12 in which the adapter 18 and the sleeve portion 20 are combined as one piece. However, the sleeve portion 20 can be a separate component that is crimped to the adapter 18 or attached in any suitable manner, for example, by press fitting, bonding, brazing, or welding, and preferably prior to inserting the tubing 10 and possibly the jacket into the fitting 12. The sleeve portion 20 preferably is made of metal or a metal alloy, but can be made of other formable materials such as plastics, polymers or elastomers. The sleeve portion 20 has a proximal end 22 and a distal end 24, the proximal end 22 being located near or adjacent to a connection with a remaining portion of the adapter 18, where the distal end 24 is located away from the adapter/sleeve portion interface.

The sleeve portion 20 is configured to receive a bushing 26a inside the sleeve portion 20 and an axial nut 28 on the outside of the sleeve portion 20. The exterior of the sleeve portion 20 preferably is threaded (not shown) to receive the nut 28. The bushing 26a includes a plurality of fingers 30a configured to engage at least one corrugation groove 16b when an axial nut 28 is tightened. As the nut is tightened, the nut 28 moves axially toward the proximal end of the sleeve portion 20, applying axial force to the bushing 26a. The bushing 26a, engaged with one or more of the corrugation grooves 16b of the tubing 10, also moves proximally.

Further movement in the axial direction, in which the bushing 26a is engaged with the one or more corrugation grooves 16b, causes a first end of the bushing to abut an end of the adapter 18, with one or more corrugations 32 of the tubing 10 received between. This movement exerts force on the tubing 10, compressing and crushing the one or more corrugations 32 located between the end of the adapter 18 and the bushing 26a to form a metal-to-metal seal that is preferably gas and liquid tight while adopting a flared shape.

The nut 28 may also be modified to adopt any necessary configuration such as a termination fitting. In particular, the nut 28 may include male threads for engaging a termination fitting.

The bushing 26a as shown in FIG. 1 preferably has first and second ends, where the first end is configured to abut against a corresponding end of the adapter 18 to form the seal. The second end of the adapter is situated distally and may include a flared portion configured to contact the nut 28.

FIG. 2 depicts another preferred embodiment of the present invention, in which the fitting 12 includes a body member or adapter 18, a sleeve portion 20, a bushing 26b, and an axial nut 28. In FIG. 2, the length of tubing 10 is partially covered by a jacket 34, which can protect the tubing 10 from potentially corrosive environments.

A primary difference between FIGS. 1 and 2 is the design of the bushing. As in FIG. 1, the bushing 26b contains a plurality of fingers 30b. However, the geometry of the fingers 30b in FIG. 2 is generally triangular as compared to FIG. 1, which features fingers 30a that are generally circular in shape. The fingers 30a, 30b of each bushing 26a, 26b respectively operate in a similar manner, i.e., they both engage one or more corrugation grooves 16b in order to compress one or more corrugations 32 to form a seal.

Various geometries, including geometries such as triangular, circular, elliptical as well as geometries that closely minor the shape of the corrugation grooves, may be advantageous with various sizes of tubing 10. Additionally, certain geometries may be desired for tubing of certain materials and thicknesses because the geometry may influence the shape that the collapsed corrugation 32 assumes.

In some embodiments, the fingers 30b have an external geometry that interacts with the internal geometry of the sleeve portion 20 to facilitate closing of the fingers and engagement of the fingers with the one or more corrugation grooves 16b. For example, the external geometry of the fingers 30b may be conical, angular, or a similar geometry to the internal geometry of the sleeve portion 20.

The bushing 26b also contains a geometry 36 for receiving an axial load. The geometry 36 may be any feature of receiving an axial load, including, but not limited to a tab, a formed feature, a ring and/or a fold. In FIG. 2, the axial load is not received directly from the axial nut 28. Rather, a washer 38 is positioned between the nut 28 and the bushing 26b. The washer 38 minimizes any torsion that might be applied to the bushing 26b from the rotation of the nut 28.

The distal end of the bushing 26b also contains one or more jacket-engaging fingers 40 which grip the jacket 34 as the nut 28 is advanced. The bushing 26b may contain a bulge 42 or other geometry that interacts with the nut 28 as the bushing 26b is advanced, causing the fingers 40 to close and engage the jacket 34, possibly by forming a crimp.

The jacket-engaging fingers 40 are advantageous in at least two respects. First, the jacket-engaging fingers 40 increase jacket 34 retention. As discussed herein, the jacket 34 protects the tubing 10 from potentially corrosive environments. Therefore, if the jacket 10 were to withdraw from the fitting 12 (e.g. due to shrinkage, changes in temperature, vibration), a portion of the tubing 10 could become compromised over time.

Second, the jacket-engaging fingers 40 may reduce stress on a portion of the tubing 10 between the region in which the fingers 40 engage the jacket 34 and the one or more collapsed corrugations 32. During installation, or in the event of a calamity such as an earthquake, force may be exerted in the tubing, pulling the tubing 10 distally from the fitting 12. While the seal formed by the one or more corrugations 32 should in all cases be capable of withstanding this force, the jacket-engaging fingers 40 provide an additional layer of support by absorbing stress and transferring the stress to the entire bushing 26b and the nut 28. Such support also may reduce vibrations and other forces which could potentially cause the tubing 10 to suffer from metal fatigue.

Threads 44 are shown in FIG. 2. The threads may be either right handed or left handed. The threads may also be straight or tapered and may be formed by cutting (e.g. with a tap or dye), rolling, or casting.

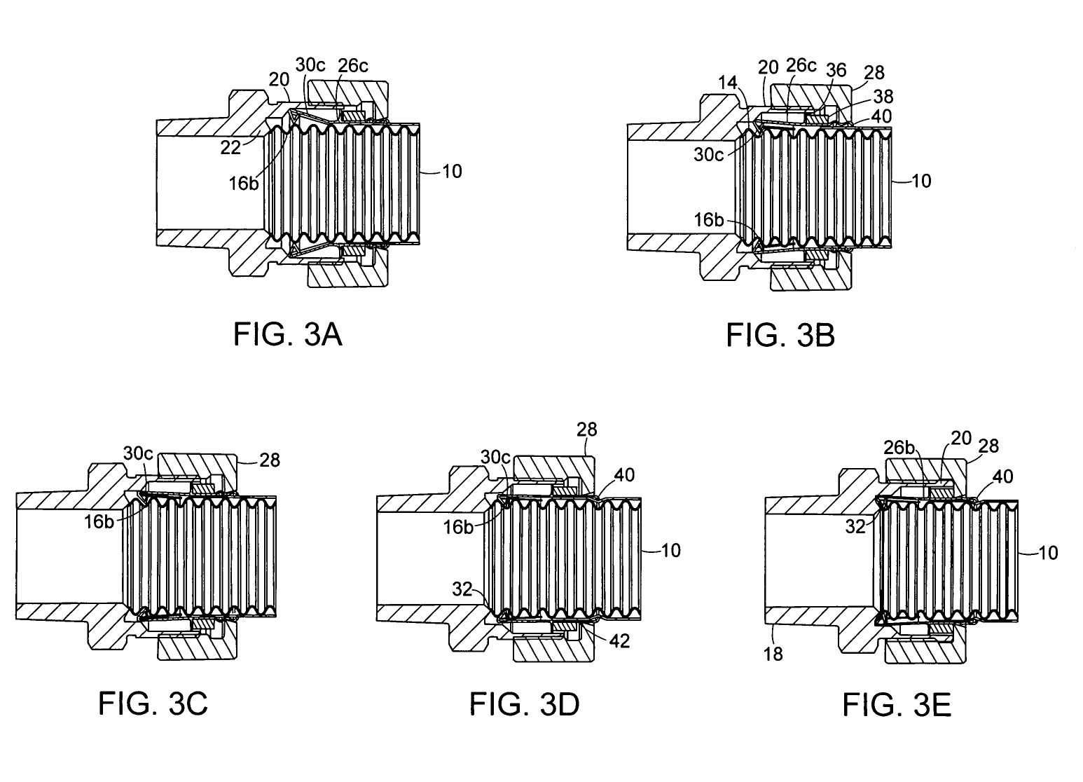

FIGS. 3a-3e depict a typical operation of the fitting. In FIG. 3a, the tubing 10 has been inserted into the sleeve portion 20. A bushing 26c (similar to the bushing 26b depicted in FIG. 2) is in a generally open configuration, i.e., the fingers 30c are configured such that the tubing 10 can pass freely through bushing 26c with little or no resistance from the bushing 26c. In some embodiments, the tubing 10 may incidentally contact the bushing 26c during insertion. In other embodiments, the fingers of the bushing 26c do not substantially expand as the tubing 10 is received in the bushing 26c. Therefore, the fingers of the bushing can be described as having a generally or substantially open configuration according to the present invention, such that the tubing received through the bushing substantially does not contact, engage, or cause expansion of the fingers when received in the fitting, although a limited amount of incidental contact with the fingers is acceptable, so long as substantial force is not required to insert the tubing into the fitting.

While the tubing 10 is shown resting against the proximal end 22 of the sleeve portion 20, the tubing 10 need not contact the sleeve portion 20 upon insertion. Rather, in some embodiments, the bushing 26c engages a corrugated groove 16b upon insertion or upon advancement of the bushing 26c.

In FIG. 3b, as the nut 28 advances, force is applied to the washer 38, which transfers the force to the load bearing geometry 36 of the bushing 26c. This force causes the bushing 26c to advance proximally. The geometry of the sleeve portion 20 forces the fingers 30c to close. As the fingers 30c are closed, the fingers 30c engage one or more corrugation grooves 16b.

In FIG. 3c, as the nut 28 further advances, the fingers 30c further close and engage the one or more corrugation grooves 16b.

In FIG. 3d, the fingers 30c have fully engaged the one or more corrugation grooves 16b. In some embodiments at this point, the internal geometry of the sleeve portion 20 is no longer angled or the angle decreases. Further advancement of the nut moves the tubing 10 proximally, placing pressure on the initial one or more corrugations 32 to crush the corrugation(s) against the adapter 22 and form a gas and liquid tight seal. Also in FIG. 3d, the nut 28 exerts force on a bulge 42 in the bushing 26c causing the jacket-engaging fingers 40 to close.

In FIG. 3e, the initial one or more corrugations 32 have been crushed to form a metal-to-metal gas and liquid tight seal. Additional pressure may have been exerted on the jacket-engaging fingers 40, causing the fingers 40 in some embodiments to penetrate the jacket 34. In the embodiment depicted, the nut 28 bottoms out against the sleeve portion 20 after the seal has been formed. This is advantageous because it prevents overtightening of the nut 28, which could damage the nut 28, bushing 26c, tubing 10, and/or the adapter 18. In other embodiments, overtightening is preventing by torque limiting nuts. Examples of such nuts include Guard-Nut SHEAR-TYPE nuts available from Guard-Nut, Inc. of Santa Rosa, Calif., in which a portion of the nut shears after a defined torque is reached.

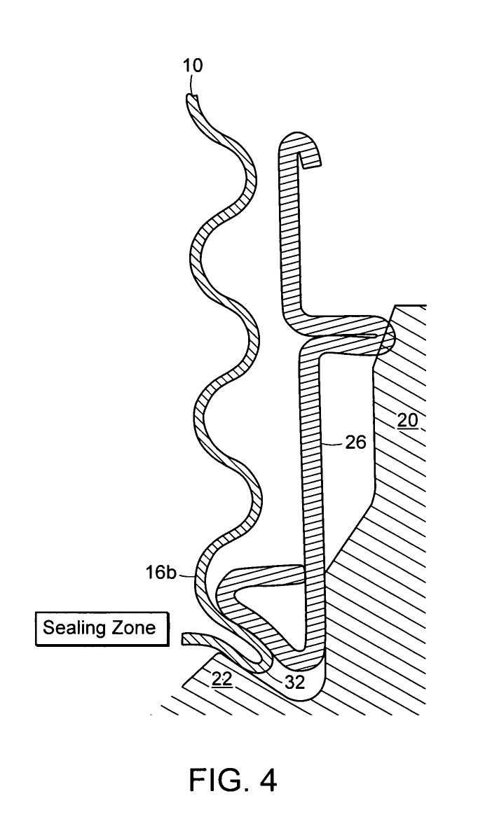

Referring now to FIG. 4, a cross-sectional view of a metal-to-metal seal is depicted. A bushing 26 has engaged a corrugation groove 16b and collapsed a corrugation against the adapter 22 to form a seal 32.

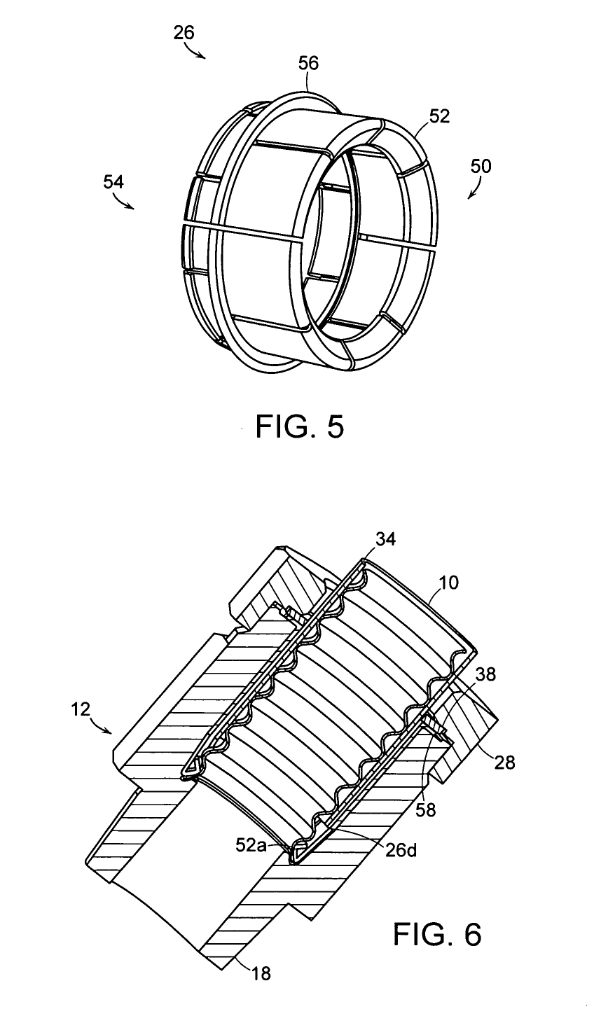

Referring to FIG. 5, a bushing 26 suitable for use with the embodiments of FIGS. 2 and 3(a)-(e) is depicted. The bushing 26 has a proximal end 50 containing a plurality of fingers 52. The bushing also has a distal end 54, which in some embodiments may have a plurality of jacket-engaging fingers (not shown). Some embodiments of the bushing 26 may include a geometry 56 to receive an axial load, such as from a nut 28 or a washer 38. The geometry may be any shape including, but not limited to a tab, a formed feature, a ring and/or a fold.

Additional characteristics of a bushing suitable for use in the present invention include, but are not limited to, the following preferred characteristics, where a bushing for use in any particular application is not necessarily required to possess any or all of these characteristics. The bushing 26 should be able to accept the corrugation 14 of the tubing 10 and should possess sufficient strength to collapse the tubing 10. The bushing 30 should have sufficient stiffness to press the corrugation 32 while being able to deflect to absorb manufacturing variances. The bushing 26 should be able to apply a sufficient axial load without buckling. The fingers 52 or corrugation contact geometry should close together to form a near complete ring around the tube corrugation to ensure sealing reliability.

The bushing 26 may be composed of any formable material including, but not limited to: metal, alloy, plastic, polymer and/or elastomer. The bushing 26 may be formed from one piece or multiple pieces of sheet stock. Alternatively, the bushing 26 may be formed through metal injection molding.

In some embodiments, the bushing 26 has a compliant nature in which the bushing 26 elastically buckles and/or deforms once a specified load factor is achieved. This prevents damage to the seal and/or the tubing 10 from overtightening. This feature also results in a bushing 26 that has a low sensitivity to manufacturing geometry variations.

FIG. 6 depicts a further embodiment of a fitting incorporating an alternative bushing design. A bushing 26d has a plurality of triangular fingers 52a. As a substitute for the triangular fingers 52a, other finger geometries may be used. Various finger geometries may be selected to reflect characteristics of the fitting 12 including, but not limited to: adapter size, shape, and/or material; whether a stop shoulder is present; and the presence, shape, and location of ridges. Finger geometries may also be affected by characteristics of the bushing 26 and the tubing 10 including but not limited to: material, size, corrugation geometry, and presence of a liner/filler material.

The bushing 26d depicted in FIG. 6 preferably includes a flange 58 on a distal end of the bushing 26d. The flange 58 can receive an axial load as the nut 28 is advanced proximally. As described herein, a washer 38 is positioned between the nut 28 and the flange 58. The washer 38 minimizes any torsion that might be applied to the bushing 26d from the rotation of the nut 28.

The present invention encompasses a method for connecting a length of corrugated tubing to a fitting, including steps of: providing a body member including a sleeve portion; providing a bushing having first and second ends and a plurality of fingers in a substantially open configuration, wherein the tubing is received through the bushing substantially without contacting the fingers of the bushing, and the fingers are configured to engage at least one corrugation groove of the tubing as the bushing is advanced; inserting the bushing in the sleeve portion; inserting the tubing into the sleeve portion and the bushing; advancing an axial nut such that the fingers engage at least one corrugation groove of the tubing; and further advancing the nut to advance the bushing to collapse the at least one corrugation groove against the body member to form a seal.

The present invention also encompasses methods for transporting gas and liquid through piping or tubing, in which at least a length of tubing is sealed to a fitting. The methods can include transporting the gas and liquid to a device, such as a boiler, furnace, or stove.

The present invention further encompasses a method for installing a piping or tubing system in a structure, such as a commercial or residential building, where the installation method includes installing at least a length of tubing that is sealed to a fitting in the manner provided above. For example, the piping or tubing system can utilize CSST tubing and fittings.

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications and other references cited herein are hereby expressly incorporated herein in their entireties by reference.

What is claimed is:

1. A sealing device for connecting a length of corrugated tubing to a fitting, comprising:
a body member including a sleeve portion;
a bushing received in the sleeve portion, the bushing having first and second ends and a plurality of fingers arranged in a substantially open configuration, wherein the tubing is received through the bushing substantially without contacting the fingers of the bushing, and the fingers are configured to engage at least one corrugation groove of the tubing as the bushing is advanced; and
an axial loading nut operably connected to the body member for advancing the first end of the bushing into engagement with the body member to form a seal.

2. The sealing device of claim 1, wherein the fingers of the bushing have a geometry that interacts with the sleeve portion to facilitate forming and sealing of the tubing, the geometry selected from the group consisting of: conical, angular, and a specific geometry of the sleeve portion.

3. The sealing device of claim 1, wherein the fingers of the bushing have a geometry to engage one or more of the corrugation grooves of the tubing, the geometry selected from the group consisting of: triangular, circular, elliptical, and a specific geometry of the tubing.

4. The sealing device of claim 1, wherein the bushing includes a geometry for receiving an axial load from the nut, the geometry selected from the group consisting of: tab, formed feature, ring, fold, and flange.

5. The sealing device of claim 1, wherein the bushing is positioned radially inside the sleeve portion.

6. The sealing device of claim 1, wherein the bushing is circumferentially continuous.

7. The sealing device of claim 1, wherein the bushing is a split bushing.

8. The sealing device of claim 1, wherein the bushing is formed by metal injection molding.

9. The sealing device of claim 1, wherein the bushing elastically deforms at a defined load rating.

10. The sealing device of claim 1, wherein the bushing is formed from at least one of the group consisting of: metal, metal alloy, plastic, polymer, and elastomer.

11. The sealing device of claim 1, wherein the sleeve portion is shaped to facilitate advancement of the bushing and engagement of the fingers.

12. The sealing device of claim 1, wherein the axial loading nut is positioned radially outside the sleeve portion.

13. The sealing device of claim 1, wherein a length of the tubing is covered by a jacket, the bushing terminates in a plurality of fingers, and the fingers engage the jacket.

14. The sealing device of claim 13, wherein the jacket-engaging fingers reduce stress on a portion of the tubing between the region in which the fingers engage with the jacket and the one or more collapsed corrugations.

15. The sealing device of claim 1, wherein the fitting further includes an adapter, and the adapter is configured to receive the sleeve portion.

16. The sealing device of claim 1, wherein the metal-to-metal seal is an annular sealing contact ring.

17. The sealing device of claim 1, wherein the nut is designed to limit the amount of torque or axial force that can be applied to the bushing.

18. The sealing device of claim 1, wherein a washer is positioned between the nut and the bushing.

19. A method for connecting a length of corrugated tubing to a fitting, comprising the steps of:
providing a body member including a sleeve portion;
providing a bushing having first and second ends and a plurality of fingers in a substantially open configuration, wherein the tubing is received through the bushing substantially without contacting the fingers of the bushing, and the fingers are configured to engage at least one corrugation groove of the tubing as the bushing is advanced;
inserting the bushing in the sleeve portion;
inserting the tubing into the sleeve portion and the bushing;
advancing an axial nut such that the fingers engage at least one corrugation groove of the tubing; and
further advancing the nut to advance the bushing to collapse the at least one corrugation groove against the body member to form a seal.

20. The method of claim 19, wherein the bushing elastically deforms at a defined load rating.

21. The method of claim 19, wherein the tubing is covered by a jacket, and advancing the axial nut further causes the bushing to engage the jacket.
